(19) United States
(12) Patent Application Publication
(10) Pub. No.: US 2013/0027213 A1
(43) Pub. Date: Jan. 31, 2013

(54) ELECTRONIC APPARATUS

(71) Applicants: Kazunori Miyata, Shijonawate-shi (JP); Saori Iwase, Daito-shi (JP)

(72) Inventors: Kazunori Miyata, Shijonawate-shi (JP); Saori Iwase, Daito-shi (JP)

(73) Assignee: SANYO ELECTRIC CO., LTD., Osaka (JP)

(21) Appl. No.: 13/559,978

(22) Filed: Jul. 27, 2012

(30) Foreign Application Priority Data
Jul. 29, 2011 (JP) 2011-167462

(51) Int. Cl. G08B 21/00

(52) U.S. Cl. 340/636.1

(57) ABSTRACT

An electronic apparatus includes an executer. An executer executes a plurality of functions. A detector detects a remaining amount of a battery attached to the apparatus. A changer changes one portion or all of the executable functions, in response to the detected remaining amount. A notifier notifies a user of an execution function changed when one portion or all of the execution functions by the executor are changed by the changer.

### CROSS REFERENCE OF RELATED APPLICATION

The disclosure of Japanese Patent Application No. 2011-167462, which was filed on Jul. 29, 2011, is incorporated herein by reference.

### BACKGROUND OF THE INVENTION

1. Field of the Invention

The present invention relates to an electronic apparatus, and in particular, relates to power saving of an electronic apparatus.

2. Description of the Related Art

Recently, the use of an electronic apparatus such as a digital camera and an IC recorder is spread. These electronic apparatuses are generally operated as a result of power being supplied from a rechargeable battery (cell battery).

An operation available time period of an electronic apparatus is determined by a consumption power per unit time of the electronic apparatus. The consumption power per unit time differs depending on a setting of each portion provided in the electronic apparatus.

For example, when the electronic apparatus is a digital camera, the consumption power per unit time differs depending on a setting state such as a brightness of a display portion such as an

LCD monitor, a drive speed of an image sensing device, and an on/off state of various types of sensors such as a GPS (Global Positioning System) and an inclination sensor.

That is, by constraining the power consumption of each portion of the electronic apparatus, it is possible to extend the operation available time period of the electronic apparatus.

According to one example of this type of moving image coding recording apparatus, when a battery remaining amount is equal to or less than a predetermined value, a power save mode is set so as to constrain the consumption power of each portion, resulting in a longer photographing time period. In this apparatus, when the battery remaining amount is equal to or less than a predetermined value, the current mode is automatically transitioned to the power save mode. However, it is not possible to know to what setting each portion of the apparatus is changed when the current mode is transitioned to the power save mode, which is not convenient to a user.

### SUMMARY OF THE INVENTION

An electronic apparatus according to the present invention comprises: an executer which executes a plurality of functions; a detector which detects a remaining amount of a battery attached to the apparatus; a changer which changes one portion or all of the executable functions, in response to the detected remaining amount; and a notifier which notifies a user of an execution function changed when one portion or all of the execution functions by the executor are changed by the changer.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing an overview of a configuration of one embodiment of an imaging apparatus 1 according to the present invention;

FIG. 2 is a block diagram showing an overview of an internal configuration of a memory 12;

FIG. 3 is a schematic diagram showing one example of setting information of the imaging apparatus 1;

FIG. 4 is an illustrative view representing one example of a notifying manner when a setting of the imaging apparatus 1 is changed;

FIG. 5 is an illustrative view representing another example of the notifying manner when the setting of the imaging apparatus 1 is changed; and

FIG. 6 is a flowchart showing a processing operation of an automatic power save mode of the imaging apparatus 1.

### DETAILED DESCRIPTION OF THE PREFERRED EMBODIMENTS

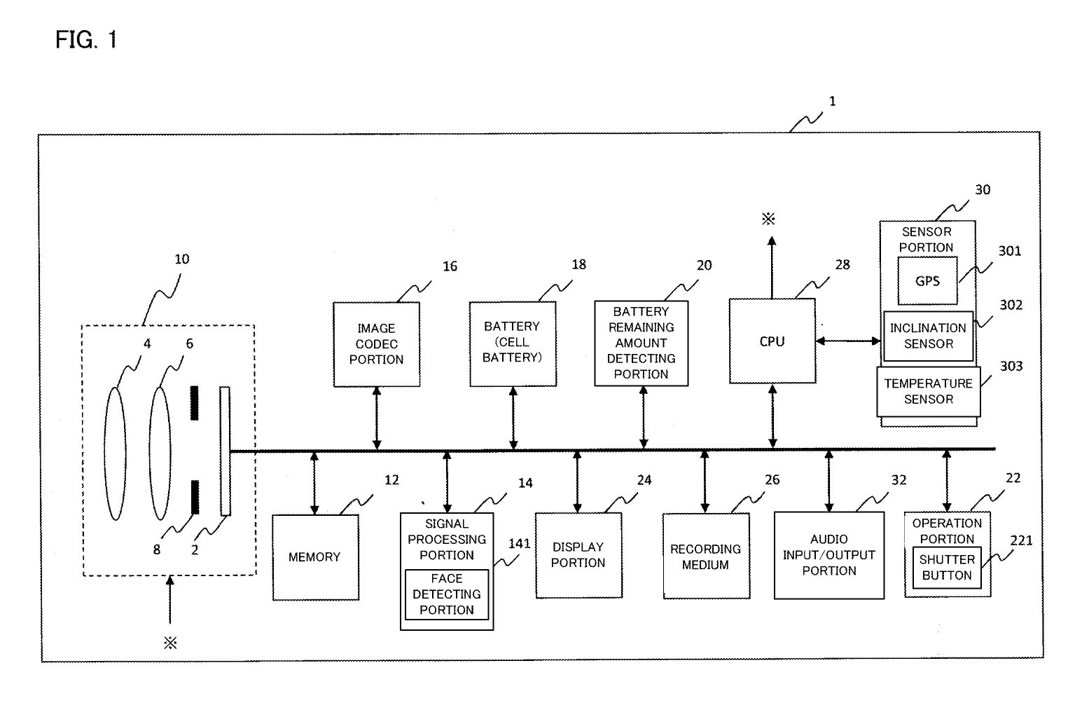

A description is provided as an example where one embodiment of the present invention is applied to an imaging apparatus such as a digital camera and a digital video camera. FIG. 1 is a block diagram showing an overview of a configuration of an imaging apparatus 1 according to the present invention.

The imaging apparatus 1 is provided with an image sensing device (image sensor) 2, a zoom lens 4 for changing a photographing field angle of a subject, a focus lens 6 for focusing on the subject, an imaging portion 10 including an aperture 8, for example, for adjusting an exposure amount.

Also, the imaging apparatus 1 is provided with a memory 12 which temporarily records an image (hereinafter, described as a subject image), etc., equivalent to a subject captured by the imaging portion, and a signal processing portion 14 which performs various types of signal processes, such as a color interpolation process, a white balance adjustment, and a noise reduction process, on the subject image temporarily recorded in the memory 12.

Furthermore, the imaging apparatus 1 is provided with an image codec portion 16 which performs a compression coding process on the subject image by a JPEG (Joint Photographic Experts Group) format when the subject image processed in the signal processing portion 14 is a still image and an MPEG (Moving Picture Experts Group) format when the same is a moving image, so as to generate a compressed image signal.

Moreover, the imaging apparatus 1 is provided with a battery 18 which supplies the apparatus 1 with power so that the same is operated, and a battery remaining amount detecting portion 20 which detects a remaining amount of the battery 18.

Furthermore, the imaging apparatus 1 is provided with a display portion 24 which displays the subject image, a recording medium 26 which records the photographed subject image, and a CPU (Central Processing Unit) 28 which controls an operation of the imaging apparatus 1.

Moreover, the imaging apparatus 1 is provided with an operation portion 22 which receives an operation from a user on the imaging apparatus 1 and applies an instruction according to the operation, to the CPU 28, and a sensor portion 30 which detects a state of the main body of the imaging apparatus 1.

Furthermore, the imaging apparatus 1 is provided with a sound input/output portion 32 including a microphone for inputting a sound and a speaker for outputting the sound.

The image sensing device 2 uses, for example, a solid-state image sensing device such as a CCD (Charge Coupled Device) image sensor, a CMOS (Complementary Metal Oxide Semiconductor) image sensor.

The memory 12 uses, for example, a generally used memory such as a VRAM (Video Random Access Memory), an SRAM (Static Random Access Memory), a DRAM (Dynamic Random Access Memory), or an SDRAM (Synchronous DRAM).

The signal processing portion 14 is provided with a face detecting portion 141 which detects whether or not a face of a human is included in the subject image captured by the imaging portion 10.

The operation portion 22 is provided with a shutter button 221 which causes a photographing process to be executed, a zoom switch (not shown) which drives the zoom lens 4 to adjust a zoom magnification of the subject, and a timer switch (not shown) which sets a self timer.

The display portion 24 uses, for example, an LCD (Liquid Crystal Display) monitor or an organic EL (Electro-Luminescence) monitor. Furthermore, the display portion 24 may be of touch-panel system which senses a contact of a finger of a human.

The recording medium 24 uses an internal recording medium, such as a flash memory or an internal HDD (Hard Disk Drive), contained in the imaging apparatus 1.

Alternately, instead of the internal recording medium, an external recording medium detachable to and from the imaging apparatus 1, such as an SD memory card, a memory stick (registered trademark), and an external HDD, may be used.

The sensor portion 30 is provided with a GPS 301 which measures a current location of the imaging apparatus 1, an inclination sensor 302 which detects an attitude of the imaging apparatus 1, and a temperature sensor 303 which detects a temperature inside a main body of the imaging apparatus 1.

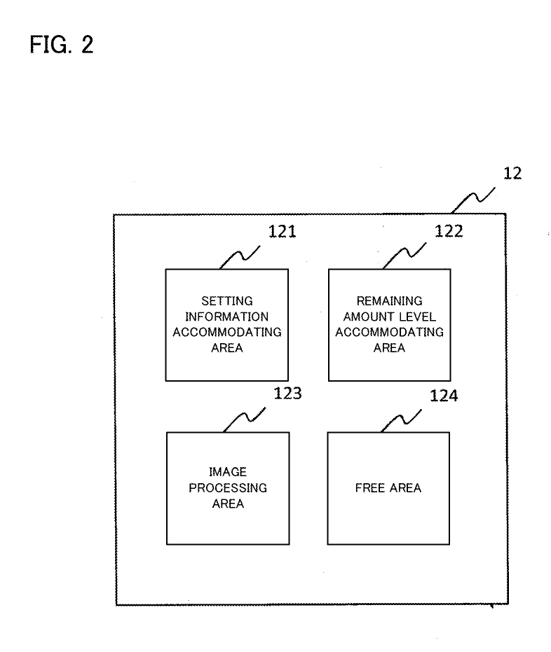

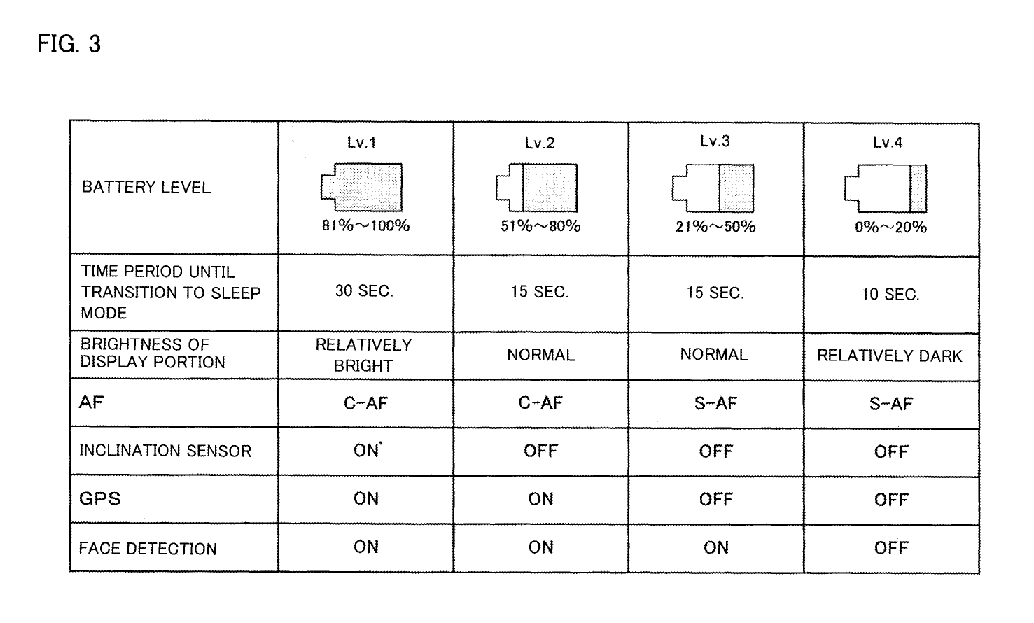

Subsequently, with reference to FIG. 2 and FIG. 3, an automatic power save mode of the imaging apparatus 1 is described. FIG. 2 is a block diagram showing an overview of an internal configuration of a memory 12. FIG. 3 is a schematic diagram showing one example of a correspondence (hereinafter, described as setting information) between the battery remaining amount of the imaging apparatus 1 and each operation setting.

The operation setting used herein refers to a combination of setting parameters of each operation setting item of the imaging apparatus 1. The operation setting item will be described later.

The memory 12 is provided with a setting information accommodating area 121 in which the setting information is accommodated, and a remaining amount level accommodating area 122 in which a variable K representing a current battery remaining amount is held.

Furthermore, the memory 12 is provided with an image processing area 123 in which image data is temporarily recorded when performing an imaging process such as a YUV conversion and a white balance adjusting process.

Furthermore, the memory 12 is provided with a free area 124 in which data other than the image data (an update program of a firmware of the imaging apparatus 1, for example) is temporarily stored.

The battery remaining amount of the imaging apparatus 1 is managed to be classified into levels of four stages (hereinafter, described as a remaining amount level) of Lv.1 to Lv.4, for example.

Lv.1 is equivalent to 81 to 100% of the battery remaining amount, Lv.2 is equivalent to 51 to 80% of the battery remaining amount, Lv.3 is equivalent to 21 to 50% of the battery remaining amount, and Lv.4 is equivalent to 0 to 20% of the battery remaining amount.

The variable K corresponds to the remaining amount level, and is accommodated in the remaining amount level accommodating area 122 in such a manner that when the remaining amount level is Lv.1, K=1; when the remaining amount level is the Lv.2, K=2; when the remaining amount level is Lv.3, K=3, and when the remaining amount level is Lv.4, K=4, respectively.

It is noted that the classification of the battery remaining amount is not limited to the above, and may be managed by further classifying it (10 stages of Lv.1 to Lv.10, for example).

The operation setting item includes six items, that is, 1. a time period until a current mode is transitioned to a sleep mode, 2. a brightness of the display portion, 3. an AF control, 4. turning on/off of the inclination sensor, 5. turning on/off of the GPS, and 6. turning on/off of a face detection function.

A combination of setting states of each operation setting item at each remaining amount level is the operation setting.

For example, when the remaining amount level is Lv.1, the operation settings are as follows: a time period until the current mode is transitioned to the sleep mode is 30 seconds; the brightness of the display portion is bright; the AF control is C-AF (Continuous-Auto Focus); the inclination sensor is on state; the GPS is on state; and the face detection function is on state.

When the remaining amount level is Lv.4, the operation settings are as follows: the time period until the current mode is transitioned to the sleep mode is 10 seconds; the brightness of the display portion is dark; the AF control is S-AF (Single-Auto Focus); the inclination sensor is an off state; the GPS is an off state; and the face detection function is an off state.

It is noted that the number of operation setting items is not limited to the above, and may be a larger number of operation setting items (10 items, for example).

Furthermore, it may be also possible for a user himself to freely customize the setting information. When the setting information is changed by the user, the setting information accommodated in the setting information accommodating area 121 is updated.

When a power source of the imaging apparatus 1 is turned on, the battery remaining amount detecting portion 20 detects the battery remaining amount of the battery 18.

The battery remaining amount can be detected from a voltage value of the power supplied from the battery 18 or from an effect situation of the voltage value, for example.

Details of a method of detecting a battery remaining amount are disclosed in Japanese Unexamined Patent Application Publication No. 2005-326233.

When the battery remaining amount of the battery 18 is detected, the battery remaining amount detecting portion 20 outputs a detection result to the CPU 28.

The CPU 28 detects the remaining amount level from the detection result outputted from the battery remaining amount detecting portion 20, generates the variable K corresponding to the remaining amount level, and accommodates it in the remaining amount level accommodating area 122.

Subsequently, the CPU 28 reads out a setting corresponding to the current remaining amount level (setting corresponding to Lv.1 when K=1, for example) from the setting information accommodating area 121, and reflects the setting in each portion.

Following this, the battery remaining amount detecting portion 20 repeats detecting the battery remaining amount for each predetermined time period (each 10 minutes, for example), and outputs the detection result to the CPU 28.

Corresponding to the detection result outputted from the battery remaining amount detecting portion 20 for each predetermined time period, the CPU 28 generates a variable Kc corresponding to the current remaining amount level, and compares it with the variable K accommodated in the remaining amount level accommodating area 122.

When K=Kc, it is determined that the remaining amount level is not changed. When K≠Kc, it is determined that the remaining amount level is changed.

When it is determined that the remaining amount level is changed, the CPU 28 updates a value of the variable K accommodated in the remaining amount level accommodating area 122, with a value of the variable Kc.

Then, the CPU 28 reads out a corresponding setting from the setting information accommodating area 121, compares it with the current setting of the imaging apparatus 1, and detects an item that needs a setting change, out of the six setting items.

For example, when the remaining amount level is changed from Lv.1 to Lv.2, three items, i.e., the time period until the current mode is transitioned to the sleep mode, the brightness of the display portion, and the on/off state of the inclination sensor, need a setting change.

The CPU 28 changes the three setting items that need the setting change, and causes the display portion 24 to display the effect that there is the setting change so that the user is notified of the change.

At this time, for example, the display is performed, as shown, so that the user can explicitly understand in what setting item the setting change occurs.

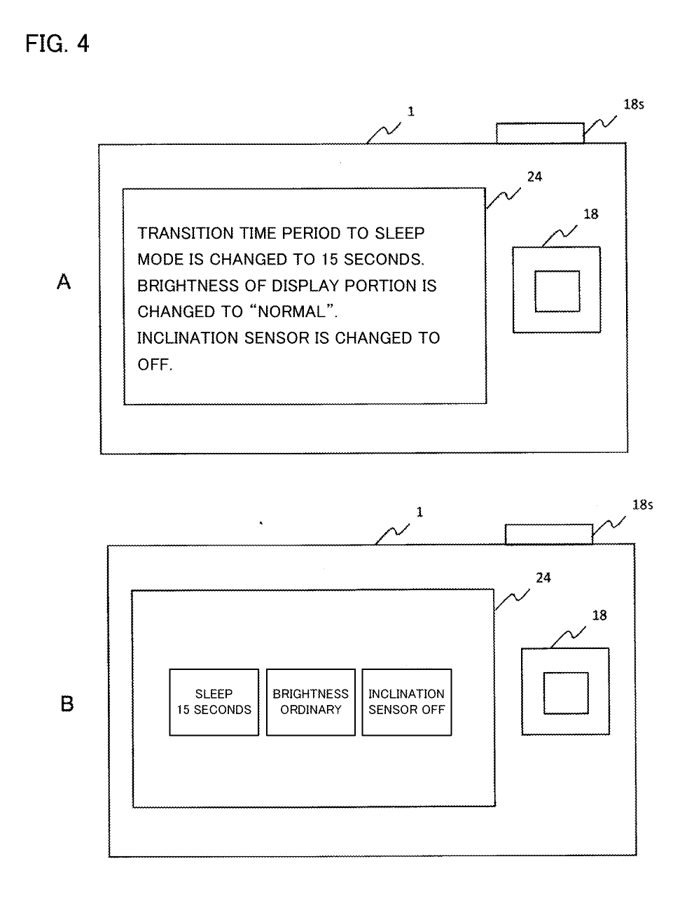

Specifically, by performing a text display as shown in FIG. 4A, or performing an icon display as shown in FIG. 4B, for example, the user is capable of explicitly understanding in what operation setting item the change occurs.

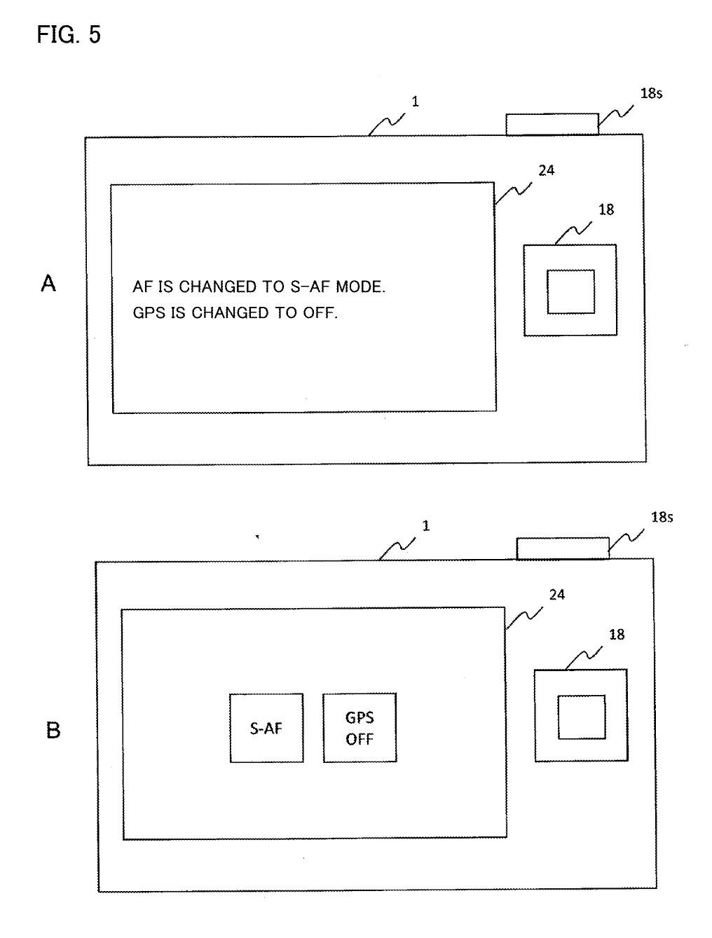

It is noted that when the remaining amount level is changed from Lv.2 to Lv.3, two items, i.e., the AF control and the on/off state of the GPS, are changed in setting, and the CPU 28 causes the display portion 24 to perform a text display as shown in FIG. 5A or an icon display as shown in FIG. 5B.

By doing this, when the setting change is applied to the imaging apparatus 1, the user is capable of understanding in what setting item the change occurs, and thus, the convenience is improved.

The automatic power save mode is repeated until the power source of the imaging apparatus 1 is turned off.

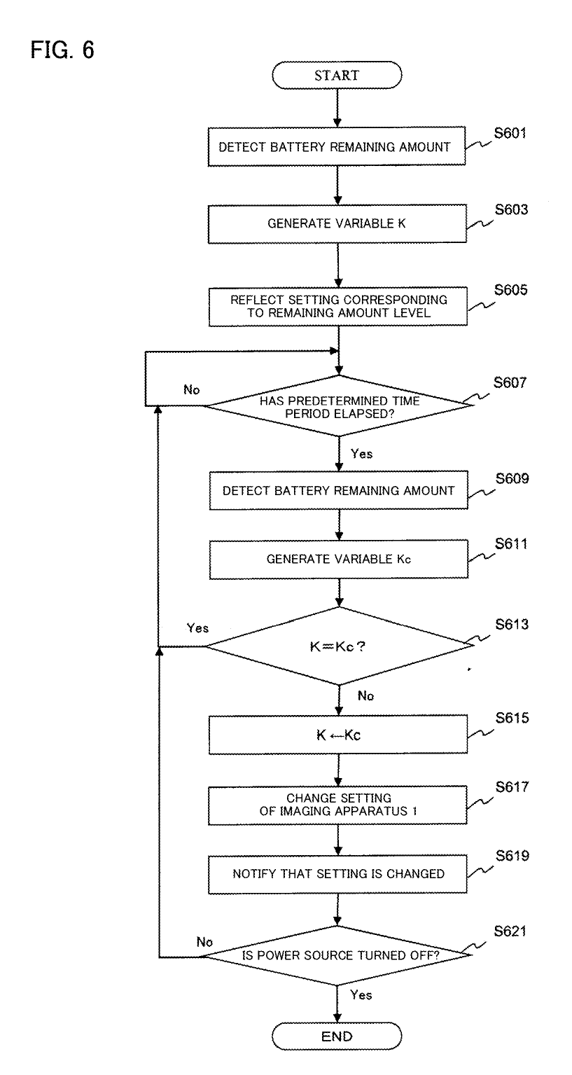

FIG. 6 is a flowchart showing a processing operation of the automatic power save mode of the imaging apparatus 1. When the power source of the imaging apparatus 1 is turned on, the process moves to a step S601.

In the step S601, the battery remaining amount detecting portion 20 detects the battery remaining amount, and outputs the detection result to the CPU 28.

In a step S603, the CPU 28 generates a variable K based on the output result from the battery remaining amount detecting portion 20, and accommodates a value of the variable K into the remaining amount level accommodating area 122.

In a step S605, a setting corresponding to the value of the variable K is read out from the setting information accommodating area 121, and reflected in each portion.

In a step S607, the CPU 28 determines whether or not a predetermined time period lapses. When the predetermined time period lapses, the process proceeds to a step S609, and otherwise, the process repeats the step S607.

In the step S609, the battery remaining amount detecting portion 20 detects the battery remaining amount, and outputs the detection result to the CPU 28.

In a step S611, the CPU 28 generates a variable Kc based on the output result of the battery remaining amount detecting portion 20. In a step S613, it is determined whether or not the value of the variable K is equal to a value of the variable Kc.

When it is determined by the CPU 28 that the value of the variable K is equal to the value of the variable Kc, the process returns to the step S607, and otherwise, the process proceeds to a step S615.

In the step S615, the value of the variable k is updated with the value of the variable Kc. In a step S617, a setting corresponding to the value of the variable K is read out from the setting information accommodating area 121, and is reflected in each portion.

In a step S619, by displaying text of the effect that the setting change occurs on the display portion 24, the user is notified. In a step S621, it is determined whether or not the user operates to turn off the power source of the imaging apparatus 1.

When the user operates to turn off the power source of the imaging apparatus 1, the automatic power save mode is ended. Otherwise, the process returns to the step S607.

In the above-described embodiment, when there is the setting change, that change is displayed on the display portion 24 in a text display or an icon display so that the user is notified; however, it may be possible to notify the user of the setting change by audio output or vibration output, for example.

Furthermore, when the remaining amount level is changed during a moving image photograph, for example, it may be possible to hold off the setting change until the moving image photograph is ended.

Furthermore, it may be possible for the user to arbitrarily turn on/off the automatic power save mode.

Furthermore, the above-described embodiment may also be applied to a case where the battery remaining amount increases by a battery recharge.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic apparatus, comprising:
an executer which executes a plurality of functions;
a detector which detects a remaining amount of a battery attached to the apparatus;
a changer which changes one portion or all of the executable functions, in response to the detected remaining amount; and
a notifier which notifies a user of an execution function changed when one portion or all of the execution functions by said executor are changed by said changer.

2. An electronic apparatus according to claim 1, wherein said notifier notifies by way of one of an audio outputter, an optical outputter, and a vibration outputter.

3. An electronic apparatus according to claim 1, further comprising an operator which accepts an instruction of a user, wherein said changer changes one portion or all the execution functions by said executor, in response to the instruction of the user accepted by said operator.

4. An electronic apparatus according to claim 1, wherein said detector repeats detecting the remaining amount for each predetermined time period.
